(19) United States
(12) Patent Application Publication
(10) Pub. No.: US 2020/0138210 A1
(43) Pub. Date: May 7, 2020

(54) System And Method Of Cushioning For Sleeping Bags

(71) Applicant: Joseph Dana, Brooklyn, NY (US)

(72) Inventor: Joseph Dana, Brooklyn, NY (US)

(21) Appl. No.: 16/182,552

(22) Filed: Nov. 6, 2018

(51) Int. Cl. A47G 9/08; A01K 1/035

(52) U.S. Cl. CPC A47G 9/086; A01K 1/035

(57) ABSTRACT

A method for providing cushioning for sleeping bags is provided. The method also comprises determining dimensions of a lower surface of an unfurled sleeping bag. The method also comprises receiving a section of spacer fabric of surface shape and dimensions approximating the dimensions of the lower surface. The method also comprises inserting the section into a pliable container of shape and dimensions accommodating the section. The method also comprises sealing the container and attaching the container to the lower surface of the unfurled sleeping bag.

### FIELD OF THE DISCLOSURE

The present disclosure is in the field of cushioning for human comfort purposes. More particularly, the present disclosure provides systems and methods for providing a compressible material inside a flexible container for attachment to sleeping bags.

### BACKGROUND OF THE DISCLOSURE

Campers and others using sleeping bags prefer comfort even in rugged environments. Sleeping on hard surfaces, whether outdoor or indoor, is not preferable to most persons. Inflatable air mattresses are well known but require the user to inflate the mattress by physically blowing into the mattress or by using a device to inflate the mattress. Such devices may be heavy and/or cumbersome and therefore not practical for campers that are hiking and therefore perhaps carrying a full load of equipment. Given choices, a camper may prefer soft, comfortable bedding that does not require inflation of mattresses but that also does not consume excessive space or is heavy.

### SUMMARY

Systems and methods described herein provide a section of cushioning material comprising spacer fabric to be sealed inside a flexible container. The container is then permanently attached to a sleeping bag to provide cushioning to the user while the sleeping back is unfurled.

### BRIEF DESCRIPTION OF THE FIGURES

FIG. 1 is block diagram of a system of cushioning for sleeping bags in accordance with the present disclosure.

FIG. 2 is diagram of a cushioning material in accordance with the prior art.

### DETAILED DESCRIPTION OF THE INVENTION

Systems and methods described herein provide for a flat, usually rectangular section of spacer fabric to be permanently attached to a downward-facing surface of an open and unfurled sleeping bag. The portion of spacer fabric provides cushioning to a user of the sleeping bag who might otherwise lie directly on hard ground. The spacer fabric portion is of dimensions approximating those of the sleeping bag when unfurled. The spacer fabric is permanently situated inside of a pliable fabric container that is attached to the sleeping bag.

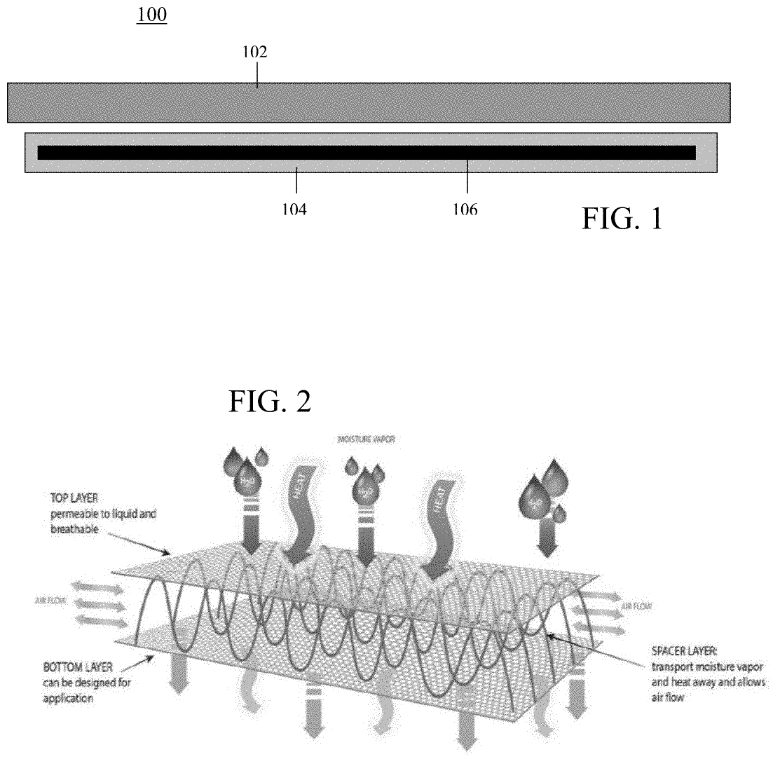

Turning to the figures, FIG. 1 is a diagram of a system of cushioning for sleeping bags in accordance with the present disclosure. FIG. 1 depicts components of a system 100 comprising a sleeping bag 102, a container 104, and a cushion 106.

The sleeping back 102 is an insulated covering for a person, essentially a lightweight quilt that may be closed with a zipper or similar means to form a tube, which functions as lightweight, portable bedding. The container 104 is a flexible bag or sack in a shape of and length and width of a downward facing surface of the sleeping bag 102 when unfurled and open on a flat surface. The container 104 may be constructed of nylon, polyester, other synthetic material, or natural material. While the length and width of the container 104 may approximate the dimensions of the sleeping bag 102, the height or thickness of the container 104 as it lays on a flat surface is sufficient to hold the cushion 106 in relaxed, uncompressed state.

Once the cushion 106 is placed inside the container 104, the container 104 is sealed and permanently attached to the downward-facing surface of the sleeping bag 102. The container 104 with cushion 106 remains attached to the sleeping bag 102 and rolls up in a layered fashion with the sleeping bag 102 as the user wishes to stow the combined components of system 100.

As the container 104, the cushion 106 within, and the sleeping bag 102 are rolled up in layered fashion, the cushion 106 compresses in a manner that the combined components may fit into a storage bag of reasonable size. When the combined components are removed from the storage bag and unfurled for use, the cushion 106 may promptly assume its uncompressed size including thickness.

FIG. 2 is a diagram of a cushioning material in accordance with the prior art. The cushion 106 may be made of spacer fabric, a known substance. FIG. 2 illustrates the characteristics of spacer fabric including permeability to moisture and breathability for the benefit of the user.

At least one section of spacer fabric is cut or otherwise produced, the section about the size of the container 104. The section is placed inside the container 104 which is then sealed and attached to the bottom surface of the sleeping bag 102.

While many sleeping bags 102 are rectangular in size when unfurled and placed on a flat surface for use, some sleeping bags 102 are not rectangular. Systems and methods described herein provide for obtaining the section of spacer fabric 106 in non-rectangular shape that approximates a non-rectangular shape of a bottom surface of a sleeping bag 102. Systems and methods described herein also provide for obtaining the container 104 in the non-rectangular shape that approximates the non-rectangular shape of a bottom surface of the sleeping bag 102. While the components of the system 100 in most embodiments are for the benefit of human users, in some embodiments the components may accommodate dogs or other animals.

Spacer fabric 106 uses two separate fabrics, joined by microfilament yarn, to create a breathable, three-dimensional “microclimate” between layers. Heat and vapor leave the body, moving to this permeable layer. Cool air provided by this ventilation then pushes out the heat and vapor, providing temperature control and maximum air circulation. Spacer fabric 106 exhibits favorable characteristics including good compression elasticity, air permeability and circulation, and good bending performance.

In embodiments, a thin sheet of nylon or other material of dimensions of the downward-facing surface of the sleeping bag may be obtained. As an alternative to the container 104, the nylon sheet may be placed between the spacer fabric 106 and the sleeping bag 102 such that the spacer fabric 106 would have direct contact with the ground. The spacer fabric 106, nylon sheet, and sleeping bag 102 would be coupled to each other in some manner.

Alternatively, the nylon sheet could be placed at the bottom of the spacer fabric 106 such that the nylon sheet has direct contact with the ground and the spacer fabric 106 is directly attached to the sleeping bag. In yet another alternative embodiment, two nylon sheets could be used, one nylon sheet above the spacer fabric 106 and hence between the spacer fabric 106 and the sleeping bag 102, and the other nylon sheet underneath the spacer fabric 106 and making direct contact with the ground.

1. A method for providing cushioning for a sleeping bag, comprising:
determining dimensions of a lower surface of an unfurled sleeping bag;
receiving a section of spacer fabric of surface shape and dimensions approximating the dimensions of the lower surface;
inserting the section into a pliable container of shape and dimensions accommodating the section;
sealing the container; and
attaching the container to the lower surface of the unfurled sleeping bag.

2. The method of claim 1, further comprising attaching the container to the lower surface via at least one of stitching, Velcro, and zipper.

3. The method of claim 1, wherein the container is constructed of at least one of at least one of nylon, polyester, and a natural material.

4. The method of claim 1, wherein the container and the section of spacer fabric within the container remain attached to the sleeping bag when the sleeping bag is rolled into a stored state.

5. The method of claim 4, wherein the container and the section of spacer fabric within the container roll in a layered manner with the sleeping bag as the sleeping bag is rolled into the stored state.

6. The method of claim 4, wherein the container and the section of spacer fabric within the container are placed in a compressed state when rolled with the sleeping bag into the stored state.

7. The method of claim 1, wherein the container and the section of spacer fabric within the container assume uncompressed state when the sleeping bag is unrolled to unfurled state.

8. A cushioning system for a sleeping bag, comprising:
a flexible container of shape and dimensions of a downward-facing surface of a sleeping bag; and
a section of spacer fabric of shape and size of the container, the section sealed inside the container,
wherein the container is attached to the sleeping bag.

9. The system of claim 8, wherein the container and the section of spacer fabric within the container remain attached to the sleeping bag when the sleeping bag is rolled into a stored state.

10. The system of claim 8, wherein the container and the section of spacer fabric within the container roll in a layered manner with the sleeping bag as the sleeping bag is rolled into the stored state.

11. The system of claim 10, wherein the container and the section of spacer fabric within the container are placed in a compressed state when rolled with the sleeping bag into the stored state.

12. The system of claim 8, wherein the container and the section of spacer fabric within the container assume uncompressed state when the sleeping bag is unrolled to unfurled state.

13. The system of claim 8, wherein the container is constructed of at least one of at least one of nylon, polyester, and a natural material

14. A support for a prone body, comprising:
a section of spacer fabric; and
a flexible sack for containing the section, the sack of shape and size matching a shape and size of the section,
wherein the sack, upon insertion of the section within, is permanently sealed and attached to a downward-facing surface of a sleeping bag.

15. The system of claim 14, wherein the sack and the contained section of spacer fabric remain attached to the sleeping bag when the sleeping bag is rolled into a stored state.

16. The system of claim 15, wherein the sack and the contained section of spacer fabric roll in a layered manner with the sleeping bag as the sleeping bag is rolled into the stored state.

17. The system of claim 15, wherein the sack and the contained section of spacer fabric are placed in a compressed state when rolled with the sleeping bag into the stored state.

18. The system of claim 15, wherein the sack and the contained section of spacer fabric assume uncompressed state when the sleeping bag is unrolled to unfurled state.

19. The system of claim 14, wherein the sack is constructed of at least one of nylon, polyester, and a natural material.

20. The system of claim 14, wherein the support is non-permanently attached to a sleeping mat for an animal.
